(19) United States
(12) Patent Application Publication
(10) Pub. No.: US 2012/0198432 A1
(43) Pub. Date: Aug. 2, 2012

(54) UPDATE MANAGEMENT APPARATUS AND UPDATE MANAGEMENT METHOD

(75) Inventor: Hiroshi Arakawa, Kawasaki (JP)

(73) Assignee: FUJITSU LIMITED, Kawasaki-shi (JP)

(21) Appl. No.: 13/441,270

(22) Filed: Apr. 6, 2012

Related U.S. Application Data
(63) Continuation of application No. PCT/JP2009/067468, filed on Oct. 7, 2009.

(51) Int. Cl. G06F 9/44

(52) U.S. Cl. 717/169

(57) ABSTRACT

An update management apparatus for updating files in a duplex system having an active information processing apparatus to perform information processing and an alternate information processing apparatus to perform the information processing in place of the active information processing apparatus. The update management apparatus includes a first update unit to update files in the alternative information processing apparatus based on update information; a synchronize unit to find files in the active information processing apparatus updated during file updating by the first update unit, and to copy found files to the active information processing apparatus; and a second update unit to re-update files copied from the active information processing apparatus to the alternative information processing apparatus by the synchronize unit based on the update information.

### CROSS-REFERENCE TO RELATED APPLICATIONS

This is a continuation of Application PCT/JP2009/067468, filed on Oct. 7, 2009, the entire contents of which are herein wholly incorporated by reference.

### FIELD

The present invention relates to an update management apparatus and an update management method.

### BACKGROUND

There are cases where one or more OS (Operating System) files or the like in an information processing apparatus, e.g. a server, are updated by applying a patch(es) in order to, for example, enhance security and/or functionality.

However, applying the patch(es) to the information processing apparatus currently being used (hereinafter, referred to as the active information processing apparatus) sometimes causes malfunction of the active information processing apparatus, thereby resulting in impediment to its operation.

Therefore, there has been proposed a method of providing an alternate information processing apparatus that can be used in place of the active information processing apparatus, applying a patch(es) to the alternate information processing apparatus, confirming whether or not the patched alternate information processing apparatus works well, and performing, if able to confirm the patched alternate information processing apparatus works well, switching from the active information processing apparatus to the alternate information processing apparatus.

By this method, it is possible to check whether or not the patched alternate information processing apparatus works well before switching from the active information processing apparatus to the patched alternate information processing apparatus. Further, since the active information processing apparatus, which is the same apparatus with the alternate information processing apparatus, exists, it is possible, even if the patching causes malfunction of the alternate information processing apparatus, to restore the patched alternate information processing apparatus to earlier state before being patched.

FIG. 11 is an explanatory diagram of the above-mentioned method (denoted hereinafter as the conventional update method) that utilizes the alternative information processing apparatus.

By the conventional update management method, to begin with, files in the active information processing apparatus 101 are copied to the alternate information processing apparatus 102 to synchronize files in the apparatuses 101 and 102 (S1). Herein, each of the apparatuses 101 and 102 has system files 91 that an operating system uses, and data files 92 each holding user data, etc.

The active information processing apparatus 101, by being used by a user(s), changes (updates, creates, deletes, or the like) some of the data files 92 (S2).

On the other hand, when a patch(es) is applied to the alternate information processing apparatus, one or more system files 91 in the alternate information processing apparatus are updated (S3). The system files 91A in FIG. 11 are the updated system files (the system files 91, some of which are updated). Note that, since time required to apply a patch(es) is roughly proportional to the number of files to be updated (patched) by the patch(es), it takes a long time to apply a patch(es) that updates many files. For instance, there are cases where about four hours is required to apply a patch(es). It is therefore desirable that the active information processing apparatus is kept in active status while the patch(es) is applied to the alternate information processing apparatus 101.

When the patching to the alternate processing apparatus 102 is completed normally, the active information processing apparatus is terminated (S4), and then the data files 92A that have been changed (modified, created, etc.) during the processing of S1-S4 are copied to the alternate processing apparatus 102 (S5).

Afterward, the alternate processing information processing apparatus 102 having the updated system files 91A and the updated data files 92A is controlled so as to operate as a new active information processing apparatus (S6).

Incidentally, as an update tool to implement a method like the above conventional update method, there exits Live Upgrade of Solaris (registered trademark). Live Upgrade has a feature of synchronizing files in a list (/etc/lu/synclist) between boot environments the first time that a newly created boot environment is booted. However, the work for preparing the list requires a lot of skill related to Solaris OS, a special knowledge of the system to be patched. Further, to utilize Live Upgrade for applying a patch(es), it is necessary to prepare the list every time patching is required.
Patent Document 1: Japanese Laid-open Patent Publication No. 2008-242679

In the case illustrated in FIG. 11, only the data files 92A in the active information processing apparatus 101 are changed while the patch(es) is applied to the alternate information processing apparatus 102. Therefore, it is possible to allow the alternate information processing apparatus 102 to inherit all processing results of the active information processing apparatus 101 by copying the data files 92A from the active information processing 101 apparatus to the alternate information processing apparatus 102.

However, the conventional update management method has such a problem that it cannot allow the alternate information processing apparatus to inherit all processing results of the alternate information processing apparatus in cases where some system files 91 in the active information processing apparatus 101 are changed while the patch(es) is applied to the alternate information processing apparatus 102.

FIG. 12 is an explanatory diagram of the problem that arises in cases where some system files 92A in the active information processing apparatus 101 are changed while the patch(es) is applied to the alternate information processing apparatus 102.

First, the files in the active information processing apparatus 101 are copied to the alternate processing apparatus 102 to synchronize the files in the apparatus 101 and 102 (S11). Herein, the system files 91 include one or more configuration files 93. The configuration files 93 are the files used for setting user's authorization, security for files, a display format of a user interface, a power management method, and the like.

The active information processing apparatus 101, by being used by the user, changes (modifies, creates, deletes, etc) some of the data files 92 and some of the configuration files 93 (S12).

On the other hand, when a patch(es) is applied to the alternative information processing apparatus 102, some of the system files 91 including the configuration files 93 are updated (S13). In FIG. 12, the configuration files 93A are the updated configuration files (the configuration files, some of which are updated), and the system files 91A are the updated system files (the system files, some of which are updated).

When the patching to the alternative information processing apparatus 102 is completed normally, the active information processing apparatus 101 is terminated (S14), and the data files 92A that have been updated while the patch(es) is applied to the alternative information processing apparatus 102 are copied to the alternative information processing apparatus 102 (S15).

Note that, if the configuration files 93B are copied to the alternate information processing apparatus 102, the patched configuration files 93A are overwritten by the configuration files 93B. The configuration files 93B are therefore not copied to the alternate information processing apparatus 102 at step S15 in order to prevent the patched configuration files 93A from being overwritten.

Subsequently, the alternate processing information processing apparatus 102 having the updated system files 91A and the updated data files 92A is controlled so as to operate as a new active information processing apparatus (S16). That is, the alternative information processing apparatus 102 having the configuration file 93A that are not the patched configuration files 93B starts operation as a new active information processing apparatus. Thus, the conventional update management method has the problem that it cannot allow the alternate information processing apparatus 102 to inherit all processing results of the alternate information processing apparatus 101 in cases where some system files 91 in the active information processing apparatus 101 are updated while the patch(es) is applied to the alternate information processing apparatus 102.

### SUMMARY

According to an aspect of the invention, an update management apparatus for updating files in a duplex system having an active information processing apparatus to perform information processing and an alternate information processing apparatus to perform the information processing in place of the active information processing apparatus includes: a first update unit to update files in the alternative information processing apparatus based on update information; a synchronize unit to find files in the active information processing apparatus updated during file updating by the first update unit, and to copy found files to the active information processing apparatus; and a second update unit to re-update files copied from the active information processing apparatus to the alternative information processing apparatus by the synchronize unit based on the update information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of an update management method;

FIG. 2 is an explanatory diagram of the update management method;

FIG. 3 is a block diagram of an alternate information processing apparatus that includes an update management apparatus;

FIG. 4 is a block diagram of an active update management apparatus;

FIG. 5 is an explanatory diagram of a watched file list;

FIG. 6 is an explanatory diagram of a process of creating a watched file list and applying a patch;

FIG. 7 is an explanatory diagram of a process of synchronizing files and re-applying a patch;

FIG. 8 is an explanatory diagram of a switching process;

FIG. 9 is an explanatory diagram of a differential copy process for not watched files

FIG. 10 is an explanatory diagram of a differential copy process for watched files

FIG. 11 is an explanatory diagram of a conventional update management method; and

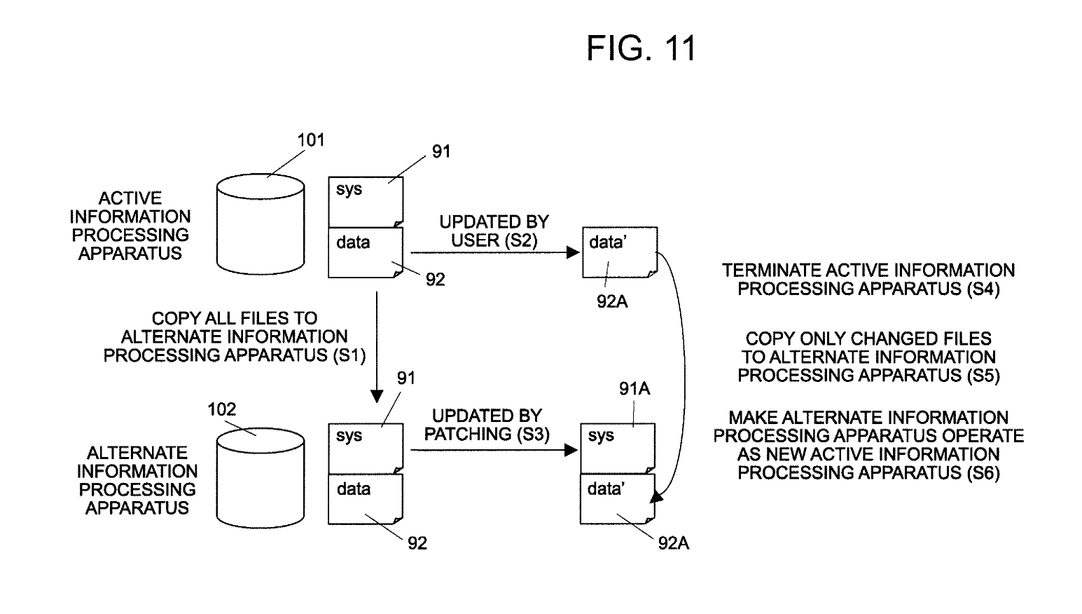

FIG. 12 is an explanatory diagram of the conventional update management method.

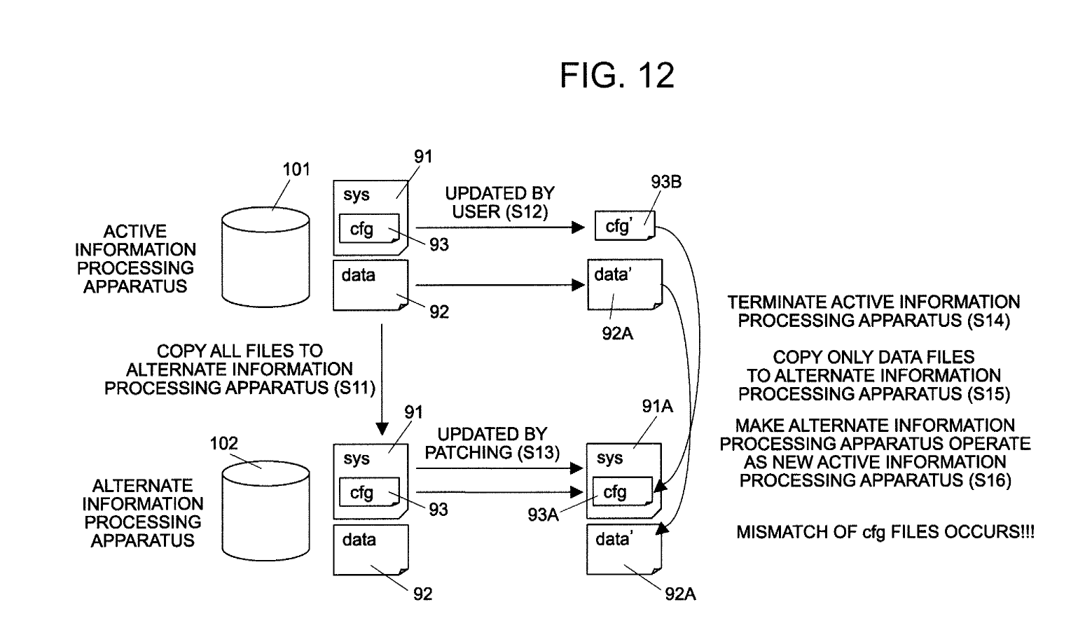

### DESCRIPTION OF EMBODIMENT(S)

An embodiment of the present invention will hereinafter be described with reference to the drawings. A configuration in the following embodiment is an exemplification, and the present invention is not limited to the configuration in the embodiment.

An update management system includes an active information processing apparatus that performs information processing based on multiple files, and an alternate information processing apparatus that is used in place of the active information processing apparatus. When files in the update management system are patched, a patch(es) is applied to the alternate information processing apparatus while the active information processing apparatus is kept in active status.

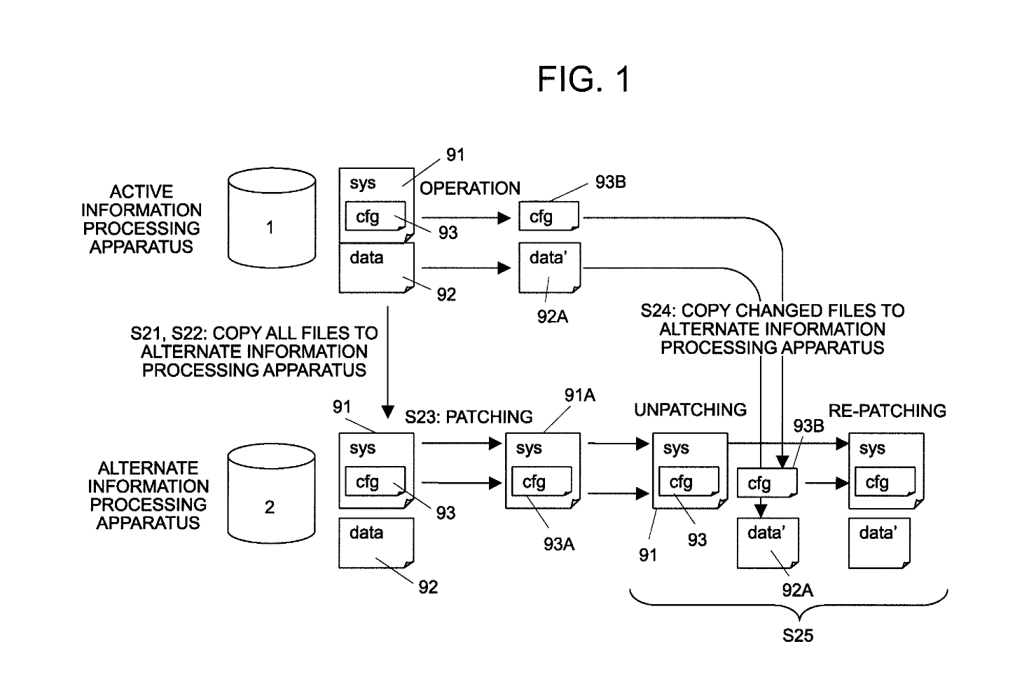

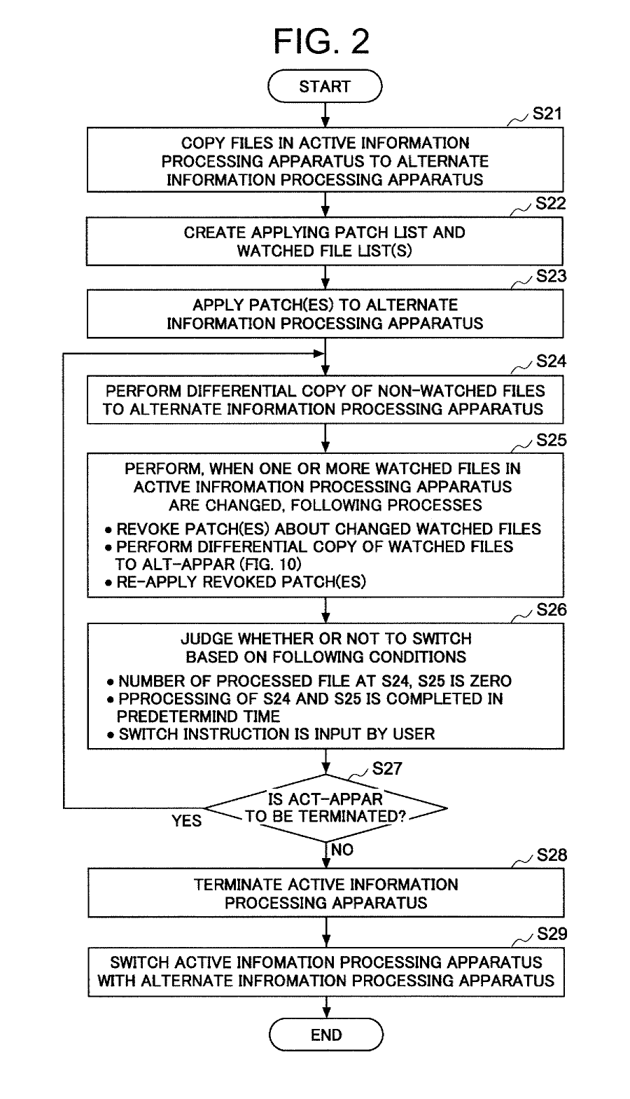

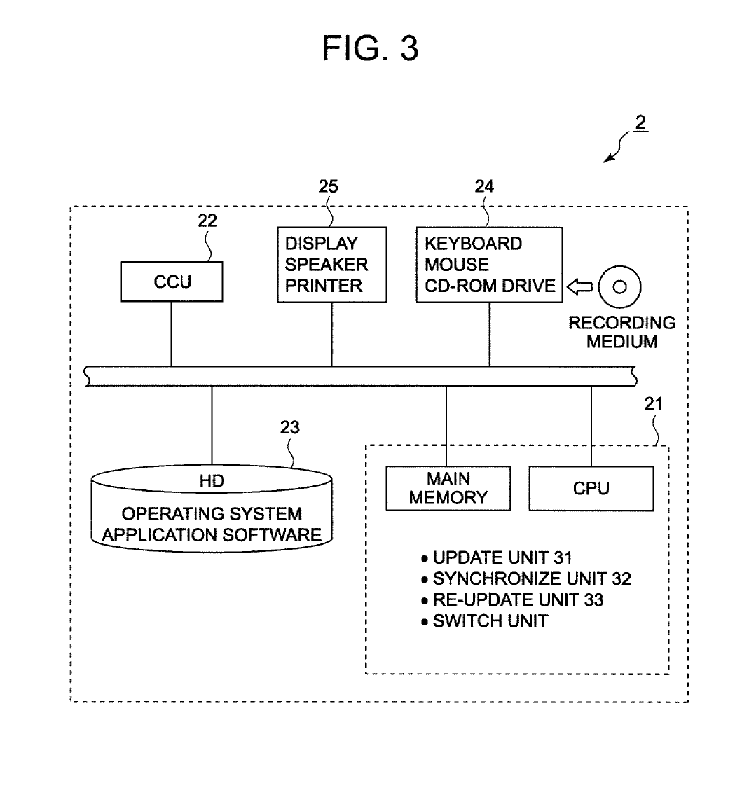

FIG. 1 and FIG. 2 are explanatory diagrams of an update management method of the present embodiment. FIG. 3 is a block diagram of the alternate information processing apparatus that includes an update management apparatus.

As illustrated in FIG. 3, the alternate information processing apparatus 2 is a computer, such as a server, provided with a data processing unit 21 that performs arithmetic processing on data, a communication control unit 22 that performs communication with another apparatus, a storage unit (a hard disk drive) 23 that stores data, an input unit 24, an output unit 25, etc.

The communication control unit 22 performs communication with a computer, such a server, that is another information processing apparatus through transmission media, e.g. communication lines that forms a network.

The storage unit 23 stores an OS, application programs including an update management program, etc.

The input unit 24 is means for inputting various pieces of information into the data processing unit 21. The input unit 24 includes user interfaces such as a keyboard, a pointing device, etc. The input unit 24 also includes a device to read data from a recording medium such as a memory card, a CD-ROM, etc.

The output unit 25 is means for outputting processing results of the data processing unit 21. The output unit 25 includes a display unit to display processing results, etc. and a printer to print data.

The data processing unit 21 includes a CPU (Central Processing Unit) and a main memory. The CPU loads the OS and one or more application programs stored in the storage unit 23 into the main memory, and performs arithmetic processing according to the loaded OS and application program(s). The CPU, by performing the arithmetic processing, serves as an update unit 31, a synchronization unit 32, a re-update unit 33, and a switch unit 34.

The CPU serving as the update unit 31 updates some files stored in the storage unit 23 of the alternate information processing apparatus 2 based on one or more pieces of update information, namely, one or more patches.

The CPU serving as the synchronization unit 32 specifies (finds) the files in the active information processing apparatus 1 that are changed by the information processing of the active information processing apparatus 1 while the files in the alternate information processing apparatus 2 are patched. Further, the CPU serving as the synchronize unit 32 copies the found files to the alternate information processing apparatus 2 while overwriting existing files in the alternate information processing apparatus, thereby synchronizing files in the apparatuses 1 and 2.

The CPU serving as the re-update unit 33 re-updates (re-patches) the files in the alternate information processing apparatus 2 that are synchronized (copied) by the synchronize unit 32 based on the patch (update information) to be applied to the synchronized files.

The CPU serving as the switch unit 34 terminates the active information processing apparatus 1 when the patching by the re-update unit 33 is completed, and performs switching between the active information processing apparatus 1 and the alternate information processing apparatus 2, thereby making the alternate information processing apparatus start operation as a new active information processing apparatus.

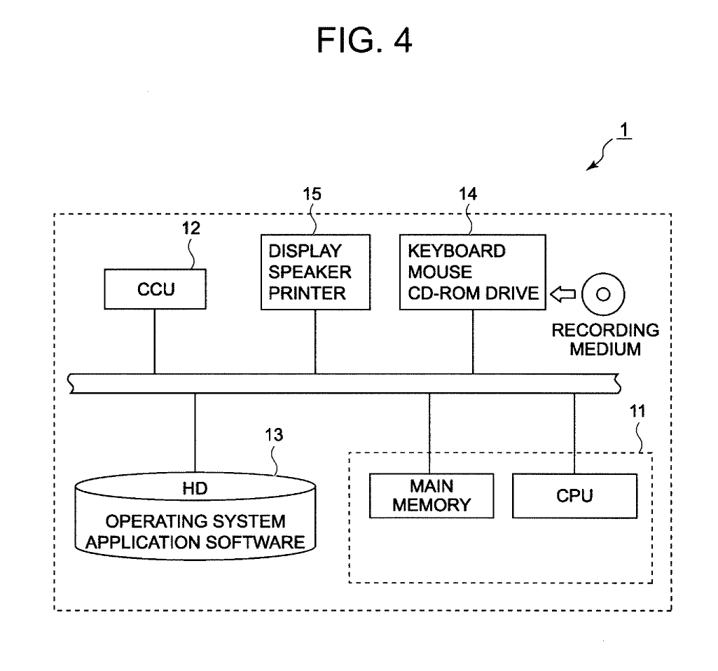

FIG. 4 is a block diagram of the active information processing apparatus 1. As illustrated in FIG. 4, the active information processing apparatus 1 is a computer provided with a data processing unit 11 that performs arithmetic processing on data, a communication control unit 12 that performs communication with another apparatus, a storage unit (a hard disk drive) 13 that stores data, an input unit 14, an output unit 15, etc.

The communication control unit 12 performs communication with another computer through transmission media, e.g. communication lines that forms a network.

The storage unit 13 stores the OS, the application programs including the update management program, etc.

The input unit 14 is means for inputting information into the data processing unit 11. The input unit 14 includes user interfaces such as a keyboard, a pointing device, etc, and a device to read data from a recording medium such as a memory card, a CD-ROM, etc.

The output unit 15 is means for outputting processing results of the data processing unit 11. The output unit 15 includes a display unit to display processing results or the like, and a printer to print data.

The data processing unit 11 includes a CPU, a main memory, etc. The CPU loads the OS and one or more application programs stored in the storage unit 13 into the main memory, and performs arithmetic processing according to the loaded OS and application program(s).

Note that, the update management system of the present embodiment has a configuration where the alternate information processing apparatus 2 also serves as the update management apparatus. However, it is possible to adopt a configuration where the active information processing apparatus 1 serves as the update management apparatus. It is also possible to adopt a configuration where the update management apparatus is an apparatus that is independent from both of the active information processing apparatus 1 and the alternate information processing apparatus 2, and provided with, for example, the update unit 31, the synchronize unit 32 and the re-update unit 33.

Moreover, each unit to process information in the alternate information processing apparatus 2 of the present embodiment, which is serving as the update management apparatus, is a unit actualized by an all-purpose processor (the CPU) and software (the update management program). However, it is possible to use, as a part or all of these units, hardware units each configured so as to have desired capability by combining basic circuits.

The update unit 31, the synchronize unit 32, the re-update unit 33, and the switch unit 34 of the alternate information processing apparatus 2 are the units to process information.

Hardware units corresponding to these units can includes one or more basic circuits such as an FPGA (Field Programmable Gate Array), an ASIC (Application Specific Integrated Circuit), and an LSI (Large Scale Integration). Further, the hardware units can includes one or more basic circuits such as an IC (Integrated Circuit), a gate array, a logic circuit, a signal processing circuit, and an analog circuit.

The logic circuit can be exemplified by an AND circuit (a logical product circuit), an OR circuit (a logical sum circuit), a NOT circuit (inverter circuit), a NAND circuit (a negated AND circuit), a NOR circuit (a negated OR circuit), a flip-flop circuit, and a counter circuit. The signal processing circuit may includes one or more circuits each performs addition, multiplication, division, reversal, product-sum operation, differentiation, and/or integration to a signal value. The analog circuit may includes one or more circuits each performs amplification, addition, multiplication, differentiation, and/or integration to a signal value.

The alternate information processing apparatus (the update management apparatus) having the configuration described above, by executing the update management program, implements the update management method whose procedure is illustrated in FIG. 1 and FIG. 2.

As illustrated in FIGS. 1 and 2, first, the synchronize unit 32 of the alternate information processing apparatus 2 copies the files stored in the storage unit 13 of the active information processing apparatus 1 to the storage unit 23 of the alternate information processing apparatus 2, thereby synchronizing files in the apparatus 1 and 2 (S21).

Herein, each of the apparatuses 1 and 2 has the system files 91 some or all of which are updated by a patch(es), and the data files 92 that are not updated by the patch(es). The system files 91 include program files each holding an OS program or an application program used for performing information processing. The data files 92 include files that are created, for example, by the information processing.

The system files 91 also include configuration files 93 relating to the settings of the information processing apparatus. The configuration files 93 are the files used for setting user's authorization, security for files, a display format of a user interface, a power management method, and the like.

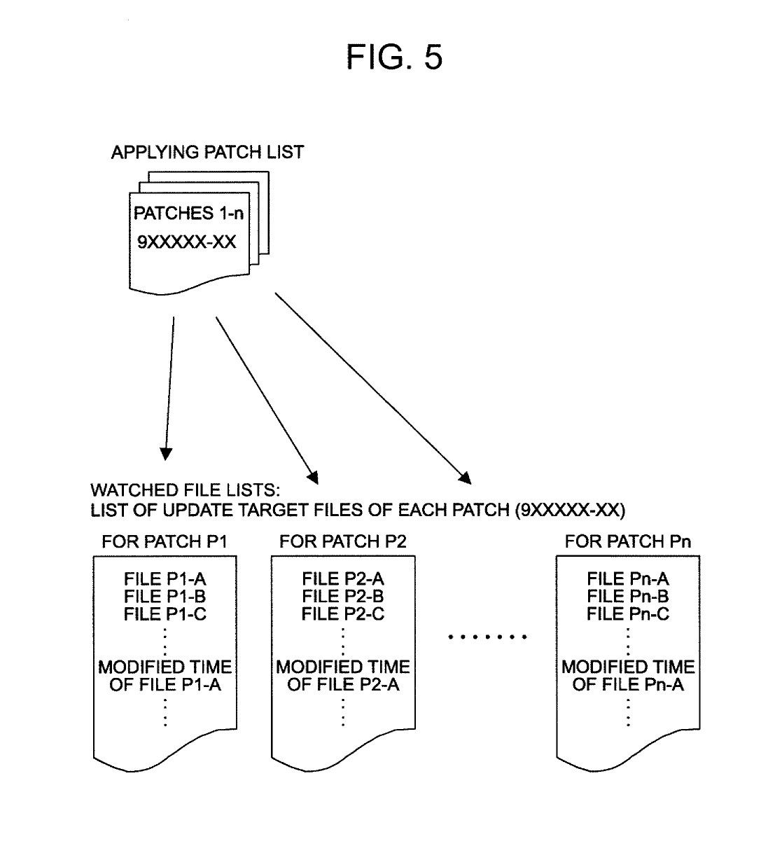

The update unit 31 of the alternate information processing apparatus 2 creates a watched file list defined as a list of files that are updating target files of one batch (S22). The update unit 31 uses, though a detailed discussion will be given later on, the created watched file list to specify the files in the active information processing apparatus 1 that are changed while the alternate information processing apparatus 2 is patched. FIG. 5 is an explanatory diagram of the watched file lists.

A patch contains the file names of the files that the patch updates. At step S22, the update unit 31 extracts all file names from the patch, and creates the watched file list containing the extracted file names. Note that, when multiple patches are to be applied, the update unit 31, with respect to each of the patches, extracts file names from the patch and creates the watched file list containing extracted file names. FIG. 5 illustrates that n pieces of watched patch lists are created from n pieces of patches labeled P1-Pn, respectively.

Moreover, the update unit 31 obtains, by accessing to the active information processing apparatus 1, information about modified time and the like of each file in the watched file list, and adds each obtained information (modified time, etc.) into the watched file list as information associated with its file name at step S22. Hereinafter, a file whose file name matches with one of file names in the watched file lists is referred as to a watched file, and a file whose file name dose not matches with any one of file names in the watched file lists is referred as to a non-watched file.

Subsequently, the update unit 31 updates some system files 91 based on the patch(es) (S23). The system files 91A in FIG. 1 are the updated system files (the system files some of which are updated).

Note that the active information processing apparatus 1, by being used by the user, changes (updates, creates, deletes, etc.) some data files 92 while the patching to the alternate information processing apparatus 2 is performed.

When the patching by the update unit 31 is completed, the synchronize unit 32 performs a differential copy of the non-watched files in the active information processing apparatus to the alternate information processing apparatus, thereby synchronizing the non-watched files in the apparatuses 1 and 2 (S24).

At the following step S25, the synchronize unit 32 judges whether or not one or more watched files in the active information processing apparatus are changed (updated).

When judging that one or more watched files in the active information processing apparatus are changed, the synchronize unit 32 unpatches the changed watched files in the alternate information processing apparatus 2 (unpatches the files in the alternate information processing apparatus 2 corresponding to the changed watched files in the active information processing apparatus 1). More specifically, the synchronize unit 32 revokes one or more patches by which the changed watched files in the alternate information processing apparatus 2 are updated.

Then, the synchronize unit 32 performs a differential copy of the watched files in the active information processing apparatus to the alternate information processing apparatus (“ALT-APPAR” in FIG. 2). That is, the synchronize unit 32 copies only the changed watched files in the active information processing apparatus 1 to the alternate information processing apparatus 2.

Subsequently, the re-update unit 33 re-applies the one or more patches that are revoked by the synchronize unit 32 to the files in the alternate information processing apparatus 2, and the re-update unit 33 and the synchronize unit 32 finishes step S25.

On the other hand, when judging that any one of the watched file in the active information processing apparatus is not changed, the synchronize unit 32 (and the re-update unit 33) finishes step S25 without performing process of revoking the patch, etc.

At the following step S26, the switch unit 34 judges whether or not to perform switching between the active information processing apparatus 1 and the alternate information processing apparatus 2. The switch unit 34 judges that switching is required (the active information processing apparatus 1 (“ACT-APPAR” in FIG. 2) is to be terminated), for example, when one of the following conditions is satisfied.

1. The number of the files processed at steps S24 and S25 is zero.
2. The time required for steps S24 and S25 is equal to or shorter than a predetermined time.
3. A switch instruction is input by a user.

Note that it is possible to use, instead of the condition 2 (or 1), a condition that the number of the files processed in steps S24 and S25 is equal to or smaller than a predetermined number, a condition that the total size of the files copied in steps S24 is equal to or smaller than a predetermined size, etc.

When the switch unit 34 judges that switching is not required (S27, No), the process returns to S24.

On the other hand, when judging that switching is to be performed (S27, Yes), the switching unit 34 terminates the active information processing apparatus 1 (S28), and make the alternate information processing apparatus start operation as a new active information processing apparatus by performing switching between the apparatus 1 and 2 (S29).

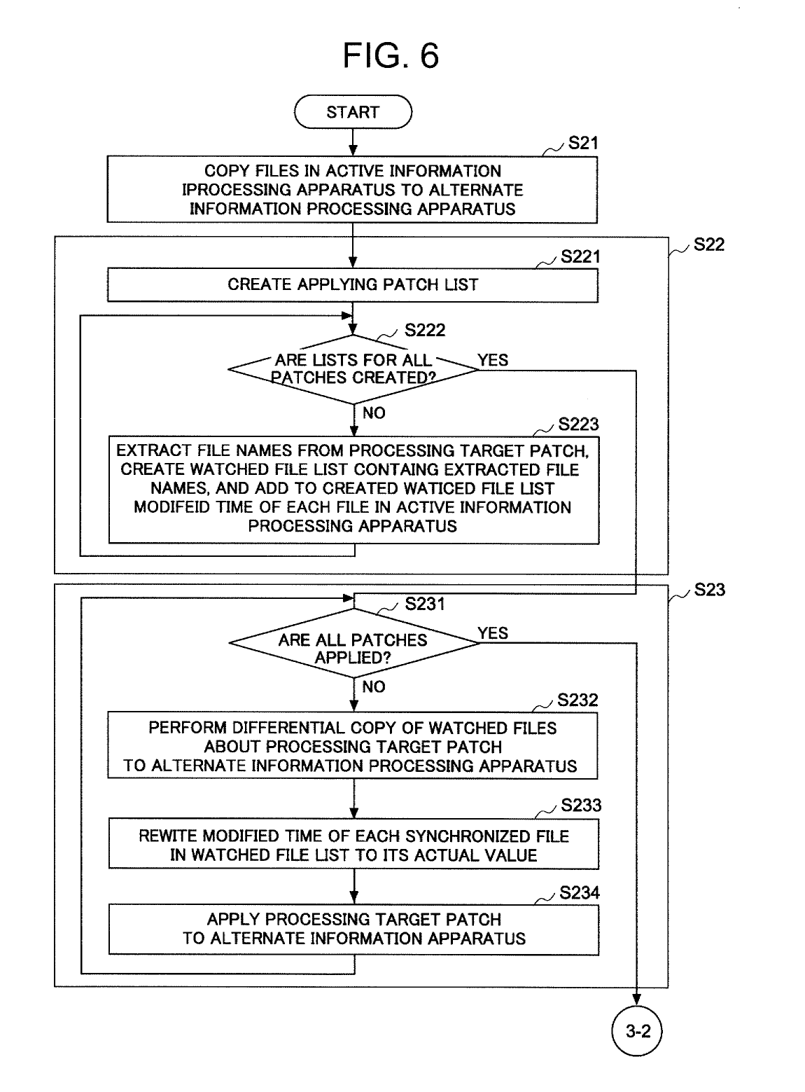

FIG. 6 is a detailed explanatory diagram of steps S22 and S23.

As illustrated in FIG. 6, the update unit 31 having copied files at step S21 performs steps S221-S223 as the process of step S22. At step S221, the update unit 31 creates an applying patch list. The applying patch list is a list indicating order in which patches are to be applied. As this applying patch list, for example, a list of patch numbers P1-Pn in ascending order is created.

Subsequently, the update unit 31 analyzes patches one by one based on the applying patch list and create a watched file list for each patch (S222, S223). At these steps, the update unit 31, with respect to each patch (“the processing target patch” in FIG. 6) in the applying patch list, extracts file names from the patch, and creates a watched file list holding the extracted file names. Further, the update unit 31, with respect to each created watched file list, obtains, by accessing to the active information processing apparatus 1, information about modified time, size, etc. of each watched file in the watched file list, and adds each obtained information of the watched file into the watched file list as information associated with its file name.

When creating the watched file lists for respective patches are completed (S222, Yes), the update unit 31 terminates step S22 (steps S221-S223), and advances to step S23.

As the process of S23, steps S231-S234 are performed by the update unit 31 and the synchronize unit 32. At step S231, the update unit 31 judges whether or not applying all patches is completed. If applying all patches is not completed (S231, No), the synchronize unit 32 selects an unprocessed patch from the applying patch list as the processing target patch, and specifies the watched file list for the processing target patch (S232). Then, the synchronize unit 32 performs a differential copy of the watched files in the specified watched file list to the alternate information processing apparatus 2, thereby synchronizing the watched files relating to the processing target patch in the apparatuses 1 and 2 (S232)

Subsequently, the synchronize unit 32 rewrites the modified times in the specified watch file list relating to the synchronized files to the modified times of the synchronized files in the active information processing apparatus 1, i.e. their actual values (S233).

At the following step S234, the update unit 31 applies the processing target patch to some files in the alternate information processing apparatus 2.

When applying the processing target patch is completed, the process returns to S232, and it is judged whether or not applying all patches is completed. If there remains one or more unprocessed patches (S231; NO), the update unit 31 and the synchronize unit 32 performs steps S232-S234 for the next patch in the applying patch list.

When applying all patches is completed (S231; YES), the update unit 31 terminates step S23 and advances to step S24.

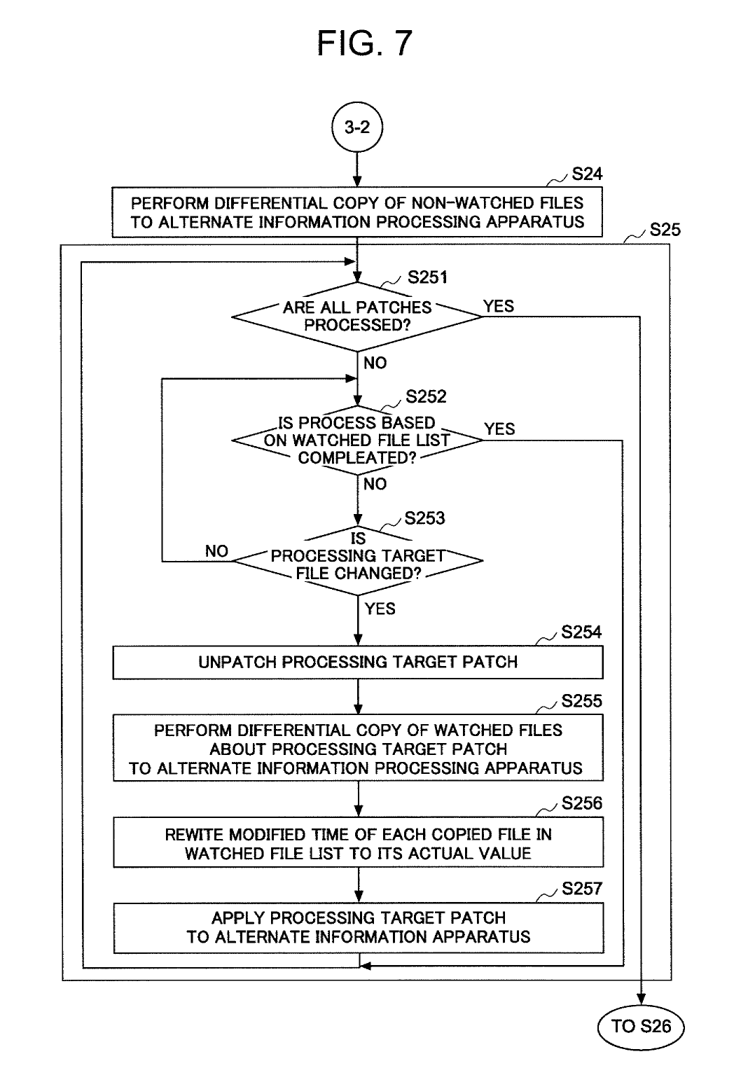

FIG. 7 is a detailed explanatory diagram of synchronizing and re-patching process (S25).

As illustrated in FIG. 7, when the differential copy (S24) is finished, steps S251-S237 are performed as the synchronizing and re-patching process (S25)

At step S251, the synchronize unit 32, to begin with, tries to select an unprocessed patch from the applying batch list. Herein, the unprocessed patch is defined as a patch, steps S252-S257 for which are not yet performed. Then, the synchronize unit 32, if able to select an unprocessed patch from the applying batch list, judges that some patches are not yet processed. Whereas if unable to select an unprocessed patch from the applying batch list, the synchronize unit 32 judges that all patches are already processed.

When judging that some patches are not yet processed (S251; NO), the synchronize unit 32 judges whether or not a process based on a watched file list is completed (S252).

The synchronize unit 32 having started step S252 first tries to select an unprocessed watched file from the watched file list for the processing target patch. Herein, the processing target patch is defined as the unprocessed patch that the synchronize unit 32 selects at S251, and the unprocessed watched file is defined as a watched file, step S253 for which is not yet performed.

Then, the synchronize unit 32, if able to select an unprocessed watched file from the watched file list for the processing target patch, judges that the process based on the watched file list is not completed (S252; NO). Whereas if unable to select an unprocessed watched file from the watched file list for the processing target patch, the synchronize unit 32 judges that the process based on the watched file list is completed (S252; YES).

When judging that the process based on the watched file list is not completed (S252, NO), the synchronize unit 32 judges whether or not the processing target file (the unprocessed file selected at S252) in the active information processing apparatus is updated (S253).

At this step, the synchronize unit 32 compares the modified time of the processing target file in the processing target watched file list and the actual modified time of the processing target file in the active information processing apparatus 1. Then, the synchronize unit 32 judges that the processing target file is not updated if the two modified times are identical. On the other hand, the synchronize unit 32, if the two modified times are not identical, judges that processing target file is updated.

When judging that the processing target file is not changed (S253; NO), the synchronize unit 32 performs steps S252 and S253. That is, the synchronize unit 32 selects a new processing target file (a new unprocessed file) from the processing target list, and judges whether or not the new processing target file is updated.

When finding an updated watched file (S253; YES), the synchronize unit 32 revokes the processing target patch (S254). In other words, the synchronize unit 32 restores the watched files that are updated by the processing target patch to the watched files before being undated by the processing target patch.

Then, the synchronize unit 32 performs a differential copy of the watched files in the processing target watched file list (the watched file list for the processing target patch) to the alternate information processing apparatus 2, thereby synchronizing the watched files that are updating target files of the processing target patch in the apparatuses 1 and 2 (S255).

Moreover, the synchronize unit 32 rewrites the modified times of the synchronized (copied) watched files in the processing target watched file list to their actual values (S256).

At the following step S257, process of re-applying the processing target patch is performed by the re-update unit 33

When step S257 is finished, processing from step S251 is re-started. The processing from step S251 is also re-started when unable to select an unprocessed watched file from the watched file list for the processing target patch (S252; YES).

When steps S252-S257 for every patch in the applying patch list are completed (S251; YES), the update unit 31 finishes step S25 and advances to step S26.

Note that the reason why the processing target patch is revoked at step S254 and then the processing target patch is re-applied at step S257 is that there are patches that cannot be applied multiple times. Consequently, step S254 can be omitted in cases where every patch is one that can be applied multiple times without causing any trouble.

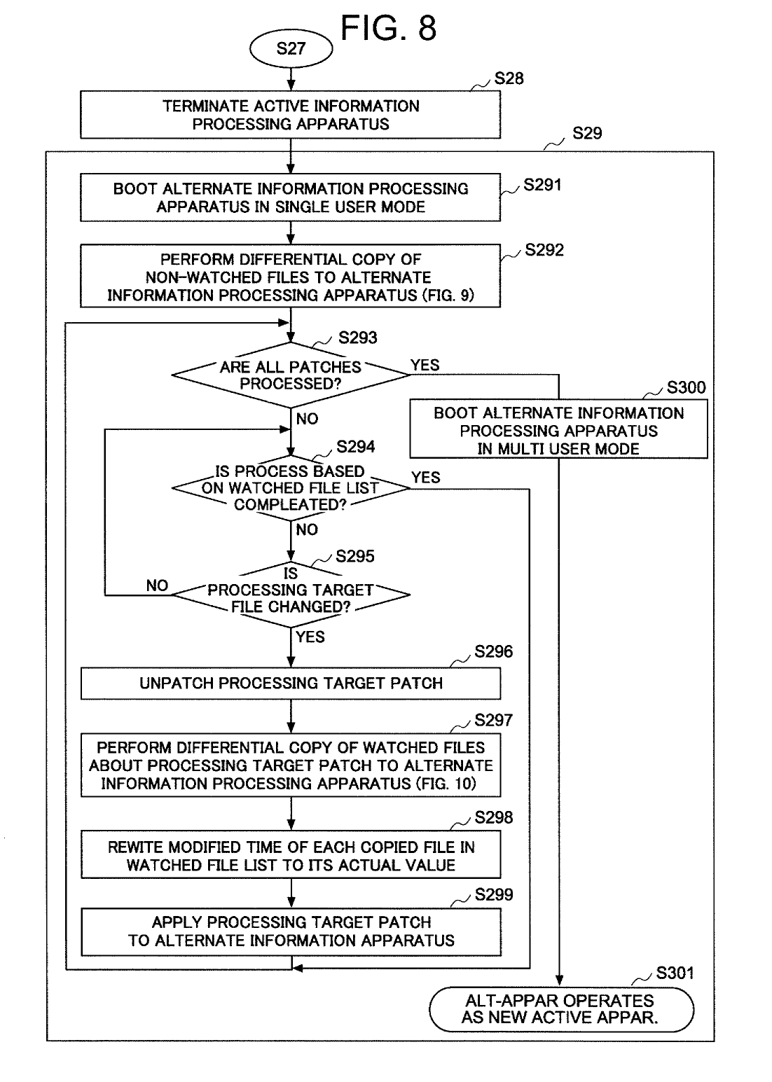

FIG. 8 is a detailed explanatory diagram of the switching process of step S29.

As illustrated in FIG. 8, the switch unit 34 having terminated the active information processing apparatus 1 (S28) boots the alternative information processing apparatus 2 in a single user mode, i.e. a mode in which the apparatus 2 does not give its service to other users (S291).

Then, the synchronize unit 32 performs a differential copy of the non-watched files (the files other than the watched files in the watched file lists) in the active information processing apparatus to the alternate information processing apparatus 2 (S292).

At the following step S293, the synchronize unit 32 tries to select an unprocessed patch (a patch, steps S294-S299 for which are not yet performed) from the applying batch list. Then, the synchronize unit 32, if able to select an unprocessed patch from the applying batch list, judges that some patches are not yet processed. Whereas if unable to select an unprocessed patch from the applying batch list, the synchronize unit 32 judges that all patches are already processed.

When judging that some patches are not yet processed (S293; NO), the synchronize unit 32 judges whether or not a process based on a watched file list is completed (S294).

At this step, the synchronize unit 32 tries to select an unprocessed watched file from the watched file list for the processing target patch. Herein, the processing target patch is defined as the unprocessed patch that the synchronize unit 32 selects at S293, and the unprocessed watched file is defined as a watched file, step S295 for which is not yet performed.

Then, the synchronize unit 32, if able to select an unprocessed watched file from the watched file list for the processing target patch, judges that the process based on the watched file list is not completed (S294; NO). Whereas if unable to select an unprocessed watched file from the watched file list for the processing target patch, the synchronize unit 32 judges that the process based on the watched file list is completed (S294; YES).

When judging that the process based on the watched file list is not completed (S294; NO), the synchronize unit 32 judges whether or not the processing target file (the unprocessed file selected at S294) in the active information processing apparatus is updated (S295).

At step S295, the synchronize unit 32 compares the modified time of the processing target file in the processing target watched file list and the actual modified time of the processing target file in the active information processing apparatus 1. Then, the synchronize unit 32 judges, if the two modified times are identical, that the processing target file is not changed. While on the other hand, the synchronize unit 32, if the two modified times are not identical, judges that processing target file is changed.

When judging that the processing target file is not changed (S295; YES), the synchronize unit 32 re-performs steps S294 and S295. Namely, the synchronize unit 32 selects a new processing target file (a new unprocessed file) from the processing target list, and judges whether or not the new processing target file is updated.

On the other hands, when finding an updated watched file (S295, YES), the synchronize unit 32 revokes the processing target patch (S296).

Then, the synchronize unit 32 performs a differential copy of the watched files in the processing target watched file list (the watched file list for the processing target patch) to the alternate information processing apparatus 2, thereby synchronizing the watched files that are updating target files of the processing target patch in the apparatuses 1 and 2 (S297).

Moreover, the synchronize unit 32 rewrites the modified times of the synchronized (copied) watched files in the processing target watched file list to their actual values (S298).

At the following step S299, process of re-applying the processing target patch is performed by the re-update unit 33

When step S299 is finished, processing from step S293 is re-started. The processing from step S293 is also re-started when unable to select an unprocessed watched file from the watched file list for the processing target patch (S294; YES).

When steps S294-S299 for every patch in the applying patch list are completed (S293, YES), the switch unit 34 makes the alternative information processing apparatus 2 operate as a new active information processing apparatus by booting the alternative information processing apparatus 2 in multi-user mode (S300, S301).

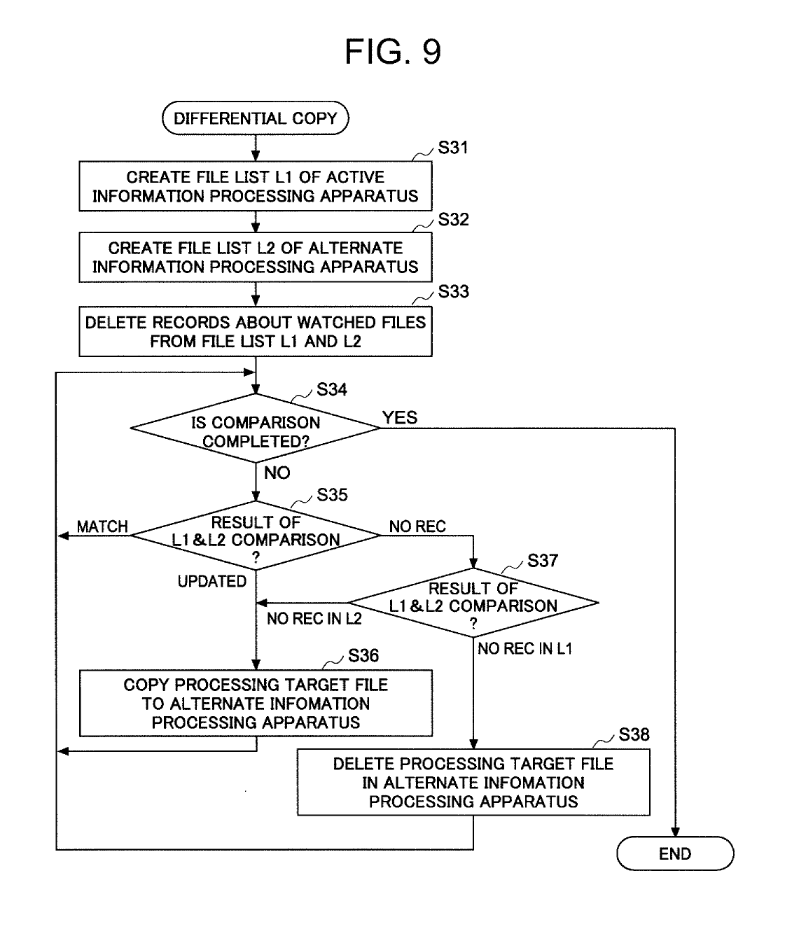

FIG. 9 is an explanatory diagram of the differential copy process for the non-watched files performed by the synchronize unit 32 at S24 in FIG. 2 and at S292 in FIG. 8.

As illustrated in FIG. 9, the synchronize unit 32 having started this differential copy process, to begin with, creates a file list L1 that is a file list of all files stored in the storage unit 13 of the active information processing apparatus 1 (S31). The synchronize unit 32 also creates a file list L2 that is a file list of all files stored in the storage unit 23 of the alternative information processing apparatus 2 (S32). Note that each of the file lists L1 and L2 that the synchronize unit 32 creates is a list containing records which correspond the respective files in the storage unit 13 or 23 and each of which holds a file name and modified time of the corresponding file.

Next, the synchronize unit 32 deletes from each of the file lists L1 and L2 records related to the watched files in the watched file lists (S33).

Afterwards, the synchronize unit 32 judges whether or not comparison between the file lists L1 and L2 is completed (S34). More specifically, the synchronize unit 32 having started step S34, to begin with, tries to specify a processing target file that is defined as a file whose record in the file list L1 or L2 is not yet processed. Then, the synchronize unit 32 judges, if able to specify the processing target file, that comparison between the file lists L1 and L2 is not completed. On the other hands, if unable to specify the processing target file, the synchronize unit 32 judges that comparison between the file lists L1 and L2 is not completed.

When judging that comparison between the file lists L1 and L2 is not completed (S34; NO), the synchronize unit 32 compares records related to the processing target file in the file lists L1 and L2 (S35). Concretely, the synchronize unit 32, by comparing the records, judges which of the following conditions is satisfied.

1. The modified times for the processing target file in the file lists 1 and 2 matches.
2. The modified times for the processing target file in the file lists 1 and 2 dose not matches.
3. The record for the processing target file exits only in the file list L1.
4. The record for the processing target file exits only in the file list L2.

When judging that the modified times for the processing target file in the file lists 1 and 2 matches (S35; MATCH), the synchronize unit 32 re-starts the processing from step S34. When judging that the modified times for the processing target file in the file lists 1 and 2 dose not match (S35; UPDATED), the synchronize unit 32 copies processing target file to the alternate information processing apparatus 2 (S36), and then re-starts the processing from step S34.

When judging that the record for the processing target file exits only in the file list L1 (S35; NO REC, S37; NO REC IN L2), the synchronize unit 32 copies the processing target file to the alternate information processing apparatus 2 (S36), and re-starts the processing from step S34. When judging that the record for the processing target file exits only in the file list L2 (S35; NO REC, S37; NO REC IN L1), the synchronize unit deletes the processing target file in the alternate information processing apparatus 2 (S38), and re-starts the processing from step S34.

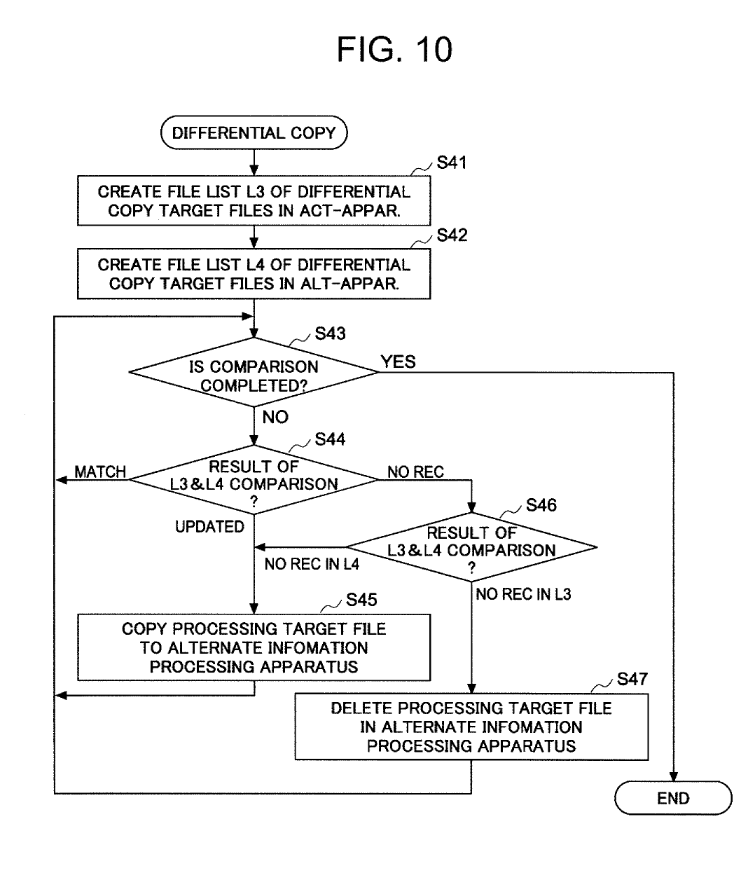

FIG. 10 is an explanatory diagram of the differential copy process for the watched files performed by the synchronize unit 32 at S25 in FIG. 2 and at S297 in FIG. 8.

As illustrated in FIG. 10, the synchronize unit 32 having started this differential copy process first creates a file list L3 (S41) and then creates a file list L4 (S42). The file list L3 is a list containing records which correspond the respective files that is updated when the processing target file is applied to the active information processing apparatus 1. Each of the records in the file list L3 holds a file name and a modified time of the corresponding file. Namely, the file list L3 is the same list as the watched file list for the processing target patch that is created at step S22 in FIG. 2. Consequently, instead of creating the file list L3, the watched file list for the processing target patch can be utilized as the file list L3.

The file list L4 is a list containing records which correspond the respective files that is updated when the processing target file is applied to the alternate information processing apparatus 2. Each of the records in the file list L4 holds a file name and a modified time of the corresponding file. This file list L4 is created, for example, by modifying the file list L3.

The synchronize unit 32 having created file lists L3 and L4 judges whether or not comparison between the file lists L3 and L4 is completed (S43). The synchronize unit 32 having started this step S43, to begin with, tries to specify a processing target file that is defined as a file whose record in the file list L3 or L4 is not yet processed. Then, the synchronize unit 32 judges, if able to specify the processing target file, the synchronize unit 32, that comparison between the file lists L3 and L4 is not completed. On the other hands, if unable to specify the processing target file, the synchronize unit 32 judges that comparison between the file lists L3 and L4 is not completed.

When judging that comparison between the file lists L3 and L4 is not completed (S43; NO), the synchronize unit 32 compares records for the processing target file in the file lists L3 and L4 (S44). At this step, the synchronize unit 32 judges, by comparing the records, which of the following conditions is satisfied.

1. The modified times for the processing target file in the file lists 3 and 4 matches.
2. The modified times for the processing target file in the file lists 3 and 4 dose not matches.
3. The record for the processing target file exits only in the file list L3.
4. The record for the processing target file exits only in the file list L4.

When judging that the modified times for the processing target file in the file lists 3 and 4 matches (S44; MATCH), the synchronize unit 32 re-starts the processing from step S43. When judging that the modified times for the processing target file in the file lists 3 and 4 dose not match (S44; UPDATED), the synchronize unit 32 copies processing target file to the alternate information processing apparatus 2 (S45), and re-starts the processing from step S43.

When judging that the record for the processing target file exits only in the file list L3 (S44; NO REC, S46; NO REC IN L4), the synchronize unit 32 copies the processing target file to the alternate information processing apparatus 2 (S45) and re-starts the processing from step S43. When judging that the record for the processing target file exits only in the file list L4 (S44; NO REC, S47; NO REC IN L3), the synchronize unit deletes the processing target file in the alternate information processing apparatus 2 (S47), and re-starts the processing from step S43.

As discussed above, the update management apparatus (the alternate information processing apparatus 2) of the present embodiment has a function of copying the files that are stored in the active information processing apparatus 1 and are changed while the alternate information processing apparatus 2 is patched, and re-patching the copied file. Consequently, according to the update management apparatus, it is possible to patch files (configuration files 93) that are changed while the alternate information processing apparatus 2 is patched.

Note that the process of step S29 in FIG. 2 (steps S291-S301 in FIG. 8) is a process performed in situations where the active information processing apparatus 1 is terminated. However, as already explained (see FIG. 2), the process of step S29 is started when one of the following conditions is satisfied.

1. The number of the files processed at steps S24 and S25 is zero.
2. The time required for steps S24 and S25 is equal to or shorter than a predetermined time.
3. A switch instruction is input by a user.

That is, in the process of step S29 started as a result of satisfaction of the condition 1, steps S296-S299 are, normally (except in cases where a watched file is changed while steps S26 and S27 is performed), not performed.

On the contrary, in the process of step S29 started as a result of satisfaction of the condition 2, steps S296-S299 are performed. However, in this case, the number of files copied at step S297 becomes quite small.

Accordingly, the use of the update management apparatus of the present embodiment always enables the alternate information processing apparatus 2 to inherit all processing results of the alternate information processing apparatus in a manner where the suspension time of the update management system (the active information processing apparatus 1) is very short.

Further, the update management apparatus of the present embodiment dose not performs steps S254-S257 (FIG. 7) for the patches whose updating target files are not changed. The update management apparatus also dose not performs steps S296-S299 (FIG. 8) for the patches whose updating target files are not changed.

The update management apparatus can be therefore said to be the apparatus configured so that useless processes are not performed.

<Others>

The present invention is not limited to only the illustrated examples given above but can be, as a matter of course, changed in a variety of forms within the scope that does not deviate from the gist of the present invention.

For instance, the update management apparatus according to the embodiment discussed above is an apparatus that, in order to judge whether or not a file in the active information processing apparatus is changed, compares a modified time of the file and a modified time of its replication stored in the alternate information processing apparatus. The update management apparatus may also be configured as an apparatus that judges whether a file in the active information processing apparatus is changed by comparing sizes of the file and its replication, or by comparing sizes and modified times of the file and its replication. Further, The update management apparatus may be configured as an apparatus that keeps a log of changes of files, and judges whether a file in the active information processing apparatus is changed based on the log.

The update management program in the above-mentioned embodiment can be stored in any type of computer readable recording medium. Herein, the computer readable recording medium connotes a recording medium capable of storing information such as data and programs electrically, magnetically, optically, mechanically or by chemical action, which can be read from a computer. As the recording mediums demountable from a computer, for example, a flexible disc, a magneto-optic disc, a CD-ROM, a CD-R/W, a DVD, a DAT, magnetic tape, a memory card, etc. are given.

Further, the hard disc, the ROM (Read-Only Memory), etc. are given as the recording mediums fixed within the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

What is claimed is:

1. An update management apparatus for updating files in a duplex system having an active information processing apparatus to perform information processing and an alternate information processing apparatus to perform the information processing in place of the active information processing apparatus, the update management apparatus comprising:
a first update unit to update files in the alternative information processing apparatus based on update information;
a synchronize unit to find files in the active information processing apparatus updated during file updating by the first update unit, and to copy found files to the active information processing apparatus; and
a second update unit to re-update files copied from the active information processing apparatus to the alternative information processing apparatus by the synchronize unit based on the update information.

2. The update management apparatus according to claim 1, wherein
the first update unit updates files in the alternative information processing apparatus based on one or more pieces of the update information, and
the second update unit, when the first update unit updates files in the alternative information processing apparatus based on multiple pieces of the update information, select from the multiple pieces of the update information one or more pieces of the update information for updating the files copied from the active information processing apparatus to the alternative information processing apparatus by the synchronize unit based on the update information, and updates the files based on selected one or more pieces of the update information.

3. An update management method, performed on a computer, for updating files in a duplex system having an active information processing apparatus to perform information processing and an alternate information processing apparatus to perform the information processing in place of the active information processing apparatus, the update management method comprising:
updating files in the alternative information processing apparatus based on update information;
finding files in the active information processing apparatus updated during the updating is performed;
copying files found by the finding to the active information processing apparatus; and
re-updating files copied from the active information processing apparatus to the alternative information processing apparatus by the copying based on the update information.

4. The update management method according to claim 3, wherein
the updating updates files in the alternative information processing apparatus based on one or more pieces of the update information, and
the re-updating, when the updating updates files in the alternative information processing apparatus based on multiple pieces of the update information, selects from the multiple pieces of the update information one or more pieces of the update information for updating the files copied from the active information processing apparatus to the alternative information processing apparatus by the copying based on the update information, and updates the files based on selected one or more pieces of the update information.

5. A non-transitory computer readable medium storing a update management program causing a computer for updating files in a duplex system having an active information processing apparatus to performed information processing and an alternate information processing apparatus to perform the information processing in place of the active information processing apparatus to perform:
updating files in the alternative information processing apparatus based on update information;
finding files in the active information processing apparatus updated during the updating is performed;
copying files found by the finding to the active information processing apparatus; and
re-updating files copied from the active information processing apparatus to the alternative information processing apparatus by the copying based on the update information.

6. The non-transitory computer readable medium according to claim 5, wherein
the updating updates files in the alternative information processing apparatus based on one or more pieces of the update information, and
the re-updating, when the updating updates files in the alternative information processing apparatus based on multiple pieces of the update information, selects from the multiple pieces of the update information one or more pieces of the update information for updating the files copied from the active information processing apparatus to the alternative information processing apparatus by the copying based on the update information, and updates the files based on selected one or more pieces of the update information.
